(19) United States
(12) Patent Application Publication
(10) Pub. No.: US 2015/0040564 A1
(43) Pub. Date: Feb. 12, 2015

(54) SOLAR ENERGY SYSTEM

(71) Applicant: HSE HITIT Solar Enerji Anonim Sirketi, Istanbul (TR)

(72) Inventor: Rahmi Oguz Capan, Mugla (TR)

(73) Assignee: HSE HITIT Solar Enerji Anonim Sirketi

(21) Appl. No.: 14/521,315

(22) Filed: Oct. 22, 2014

Related U.S. Application Data
(63) Continuation of application No. PCT/EP2013/068266, filed on Sep. 4, 2013.

(30) Foreign Application Priority Data
Sep. 10, 2012 (TR) 2012/10302

(51) Int. Cl. F03G 6/06; F24J 2/34

(52) U.S. Cl. CPC F03G 6/06; F24J 2/34; F03G 2006/061
USPC 60/641.15; 126/617; 126/634

(57) ABSTRACT

A steam condensation and water distillation system comprises an evaporation compartment in a vacuum environment in which a water source is evaporated and at least one first column in which high density water is accumulated; a steam line partly located in the evaporation compartment; a condensation pool in which steam is transferred; a condensation compartment in a vacuum environment in which steam in the evaporation compartment is transferred, a second column in which water formed by the condensation of the steam is accumulated, and a water compartment which is provided with an amount of water therein, in which condensation compartment is positioned; a first water line which is in connection with the water compartment and the second column, and by which the water coming from them are transferred to the water compartment again by being cooled; a second water line by which water is transferred for using.

### CROSS-REFERENCE TO RELATED APPLICATION

In accordance with 35 U.S.C. §111(a), this application is a continuation of International Application PCT/EP2013/068266, with an international filing date of Sep. 4, 2013, and claims all benefits of said international application, which is incorporated by reference in its entirety.

### TECHNICAL FIELD

The present invention relates to solar energy systems comprising a heat storage unit.

### BACKGROUND

Decreasing limited energy sources (e.g. fossil fuel) in the world causes increasing the importance of the alternative energy resources, particularly of the renewable energy resources. Solar energy is the leading one of these renewable energy resources. By converting solar energy to e.g. electric energy, solar energy can be useful in different fields. There are different methods for converting solar energy into electric energy. One of these methods is to obtaining electric energy directly from the solar energy by using solar batteries which can be called photovoltaic batteries. However, since the cost of the solar batteries is high and the amount of the electric energy obtained from the sun is low, this method cannot be used in high capacities (e.g. meeting electricity needs of a city).

The other method used for obtaining electrical energy from the solar energy is evaporating a fluid such as water in solar energy systems (e.g. in parabolic solar trough systems or in solar towers) by heating, and operating an electric turbine (generator) by the occurred steam pressure. This type of embodiments can be used for producing electric energy in high capacities since their costs are low and their efficiencies are high. However, in this type of embodiments (in other embodiments obtaining electric energy from solar energy as well), since no sunlight comes to the thermal units (e.g. to the solar panels) in the solar energy system at nights and/or cloudy sky, electric energy cannot be produced at nights.

In the state of the art for ensuring electricity production at night, heat storage units are used in the solar energy systems provided with the thermal unit comprising elements like panel, which concentrates sunrays in a region by gathering, and pipe in which the fluid to be heated is passed. In the solar energy systems comprising heat storage unit, while a part of the heat obtained from the thermal unit operates the electric turbine, the remaining energy is stored in said heat storage unit. Heat storage units are structures comprising materials having high heat capacities and high heat exchange coefficient. Thanks to the circulation of hot fluid taken from the thermal unit inside the heat storage unit, heat energy carried by hot fluid is transferred to said materials. Therefore, the heat energy is stored by the temperature increase of said materials. When it is night (and in cloudy daytime), the fluid is heated via the heat energy stored in the storage unit by sending cold fluid to said heat storage unit; and electric turbine is operated by sufficiently heated hot fluid.

### BRIEF DESCRIPTION

The solar energy system comprises at least one liquid source, in which the liquid to be heated is provided; at least one thermal unit by which the liquid taken from the liquid source is heated via solar energy; at least one transfer element for transferring liquid from the liquid source to the thermal unit; at least one heat storage unit in multi-piece structure which is suitable for transferring the steam formed in the thermal unit, which stores the heat by absorbing the heat of the steam, which evaporates the liquid by heating the liquid by means of the heat stored when liquid is passed therethrough; at least one generator to which the steam obtained in thermal unit or heat storage unit is transferred, which ensures a motional energy via the steam pressure; and a plurality of vanes which controls transferring of the steam originated from the thermal unit selectively to the heat storage unit or to the generator.

In the solar energy system, it is ensured that the steam in desired temperature and pressure is able to be produced continuously (day/night, when the density of the sunlight changes).

An aim of the invention is to develop a solar energy system comprising a heat storage unit.

Another aim of the invention is to develop a solar energy system which has high operation efficiency.

Another aim of the invention is to develop a solar energy system which ensures hot steam in desired temperature and pressure continuously without depending on the changes of the sun rays from the sun during the day.

A further aim of the invention is to develop a solar energy system which has a long operation time even though it does not receive sunlight.

### DESCRIPTIONS OF THE DRAWINGS

Exemplary embodiments of the solar energy system are shown in attached drawings wherein;

FIG. 1 is a schematic view of the solar energy system.

FIG. 2 is a schematic view of an embodiment of the solar energy system.

FIG. 3 is a schematic view of another embodiment of the solar energy system.

FIG. 4 is a schematic view of another embodiment of the solar energy system.

FIG. 5 is a schematic view of another embodiment of the solar energy system.

FIG. 6 is a schematic view of a heat storage unit used in the solar energy system.

FIG. 7 is a schematic view of an embodiment of the heat storage unit.

FIG. 8 is a schematic view of another embodiment of the heat storage unit.

FIG. 9 is a schematic view of the solar energy system in which the heat storage unit shown in FIGS. 6-8 is used.

FIGS. 10-14 are schematic views of the exemplary embodiments of the solar energy system in which the heat storage unit shown in FIGS. 6-8 is used.

FIG. 15 is a schematic view of an alternative heat storage unit.

FIG. 16 is a schematic view of another embodiment of the alternative heat storage unit.

FIG. 17 is a schematic view of another embodiment of the alternative heat storage unit.

FIGS. 18-23 are schematic views of exemplary embodiments of the solar energy system in which the heat storage unit shown in FIGS. 15-17 is used.

The parts in the figures are individually enumerated and the corresponding terms of reference numbers are given as follows:
Liquid source (S)
Transfer element (P)
Condenser (K)
Thermal unit (T, T1, T2)
Heat storage unit (H)
Inlet (Hi)
Outlet (Ho)
First part (H1)
Second part (H2)
Third part (H3)
Fourth part (H4)
First compartment (H5)
Second compartment (H6)
Third compartment (H7)
Generator (G)
Pressure regulator (1a)
Pressure sensor (1b)
Temperature sensor (1c)
Temperature regulator (1d)
Pressure relief valve (1e)
Vane (2-9, 11a-11d, 12a-12g, V1-V9, V11-V12)

### DESCRIPTION

Solar energy systems convert solar energy into energy types which can be used in different fields. In solar energy systems ensuring the operation of a generator (e.g. an electric turbine) by forming steam, the liquid taken from a liquid source (e.g. from a water tank) is evaporated by being heated in thermal units (these thermal units comprise elements such as solar panels concentrating sun rays in a region by gathering and pipes by which the liquid is evaporated via concentrated sun rays). However, the steam is not produced in said systems when there is not any sun (e.g. at night). Moreover, in the event that the density of the sun rays are changed during the day or the sun rays are prevented by an obstacle such as cloud, steam in desired pressure and/or temperature cannot be obtained. Therefore, a solar energy system which can produce steam in desired temperature and pressure continuously (night/day) is developed by the present invention.

The solar energy system of the present disclosure whose exemplary embodiments are shown in FIGS. 1-23 comprises at least one liquid source (S), in which the liquid to be heated is provided; at least one thermal unit (T, T1, T2) by which the liquid taken from the liquid source (S) is evaporated by heating via solar energy; at least one transfer element (P) which is preferably a pump for liquid transferring from the liquid source (S) to the thermal unit (T, T1, T2); at least one heat storage unit (H) in multi-piece structure which is suitable for transferring the steam formed in the thermal unit (T, T1, T2), which stores the heat by absorbing the heat of the steam, which evaporates the liquid by heating the liquid by means of the heat stored therein when liquid is passed therethrough, and which is provided with preferably at least one inlet (Hi) and at least one outlet (Ho); at least one generator (G) by which the steam produced in the thermal unit (T, T1, T2) or in the heat storage unit (H) is transferred, which ensures a motional energy via the steam pressure, and which converts this motional energy into an electrical energy; and a plurality of vanes (2-7 or V3-V9 or V11-V12) which controls transferring of the steam originated from the thermal unit (T, T1, T2) selectively to the heat storage unit (H) or to the generator (G). Said thermal unit can be in a parabolic solar trough structure and/or a solar tower structure comprising at least one inlet by which liquid coming from the liquid source (S) is taken in and at least one outlet from which the liquid heated therein is released preferably in the form of steam. Said heat storage unit (H) preferably comprises elements such as molten salt, concrete, and/or rock. The steam entering into the heat storage unit (H) transfers its heat to said elements; thus ensures storage of the heat.

In the solar energy system, in the cases that the sun can be fully taken advantage of, the liquid received from the liquid source (S) and transferred to the thermal unit (T, T1, T2) turns into hot steam with the effect of the sun rays and is converted into e.g. motional energy by transferring to the generator (G). Moreover, hot steam obtained in said unit (T, T1, T2) is transferred to the heat storage unit (H) at the same time, and therein the obtained heat is ensured to be stored by the absorption via the elements in the heat storage unit (H). In the event that the sun rays are not sufficient to obtain hot steam at desired temperature (e.g. in the event that a part of the sun rays are blocked by the cloud bank), the steam received from the thermal unit (T, T1, T2) is not able to be at a sufficient temperature for being used in the generator (G) (in the event that sufficient heat cannot be received, whole liquid cannot be evaporated and thus the liquid can remain as a liquid-steam mixture). In this case, the fluid (liquid and/or steam) received from the thermal unit (T, T1, T2) is directed to the heat storage unit (H) in which heat is stored previously, and it is ensured that the fluid is turned into the steam in desired temperature by means of the heat absorbed by the elements located in this unit (H). Then, the steam at desired temperature is passed to the generator (G) from the heat storage unit (H) and is used therein. Therefore, in the event that the rays from the sun during the day is not sufficient to obtain the steam at desired temperature in the thermal unit (T, T1, T2), by means of transferring the fluid received from said unit (T, T1, T2) to the heat storage unit (H), it is ensured that the fluid is turned into the steam at desired temperature via the heat stored previously therein. Thus, the steam at the temperature necessary for using in the generator (G) can be obtained. The operation of the thermal unit (T, T1, T2) and the heat storage unit (H) in the solar energy system selectively depending on the conditions is ensured by opening and closing the vanes (2-7 or V3-V9 or V11-V12) located in the system in suitable combinations.

In a preferred embodiment, said solar energy system comprises at least one pressure sensor (1b) which is located preferably at the outlet of said thermal unit (T, T1, T2) (or as shown in FIGS. 1-5 before the generator (G) and the outlet (Ho) of the heat storage unit (H)) and which measures the pressure of the steam passing through place it remains; and at least one pressure regulator (1a) which is placed at the outlet of the liquid source (S), which is in connection with said pressure sensor (1b), and which ensures that the steam pressure measured by the pressure sensor (1b) reaches at a desired level by means of sending an amount of liquid received from the liquid source (S) to the liquid source (S) back according to the pressure information coming from the pressure sensor (1b) (the pressure regulator (1a) can control the amount of the liquid and/or the steam passing through the place where the pressure regulator (1a) presents). In this embodiment, it is ensured that the steam sent to the generator (G) and/or the heat storage unit (H) is at the desired pressure.

In another preferred embodiment, said solar energy system comprises at least one temperature sensor (1c) which is preferably located at the outlet of said thermal unit (T, T1, T2) (or as shown in FIGS. 1-5 before the generator (G) and the outlet (Ho) of the heat storage unit (H)) and which measures the temperature of the steam passing through the place it presents; and at least one temperature regulator (1d) which is placed between the temperature sensor (1c) and the thermal unit (T, T1, T2), which is in connection with the temperature sensor (1c) and which regulates the temperature by adjusting the flow rate of the fluid (liquid and/or steam) received from the thermal unit (T, T1, T2) depending on the value measured by the temperature sensor (1c). Moreover said temperature sensor (1c) ensures sending the liquid to the generator (G) and/or the heat storage unit (H) via said vanes (2-7) by measuring the temperature of the liquid and/or the steam which are to be sent to the generator (G) and/or to the heat storage unit (H). Therefore, instead of sending for instance the steam (can be liquid if the steam is not heated sufficiently) received from the thermal unit (T, T1, T2) directly to the generator (G), the steam is sent to the heat storage unit (H) firstly; and then sent to the generator (G) after it reaches desired temperature in heat storage unit (H).

Different embodiments are shown in exemplary schematic views given in FIGS. 1-4 (in figures, open positions of the vanes (allowing liquid and/or steam passage) are shown in hollow form ( [symbol] ) and close positions of the vanes (preventing liquid and/or steam passage) are shown in filled form ( [symbol] ). In the embodiment shown in FIG. 2, only the case the steam formed in said thermal unit (T) is sent only to the generator (G) is exemplified, and in the embodiment the heat storage unit (H) is deactivated. According to the embodiment, the liquid received from the liquid source (S) is sent to the thermal unit (T) and turns into the steam having desired temperature therein. The steam formed in the thermal unit (T) is sent to the generator (G) via a vane (3) located at the outlet of this unit (T) and via another vane (6) located at the inlet of the generator (G). In this embodiment, since the other vanes (2, 4, 5, 7) ensuring liquid and/or steam passage to the heat storage unit (H) are in closed position, the steam and/or liquid do/does not enter in the heat storage unit (H). Thus, the operation of the generator (G) is ensured for example thanks to the steam formed in said thermal unit (T) when it is sunny.

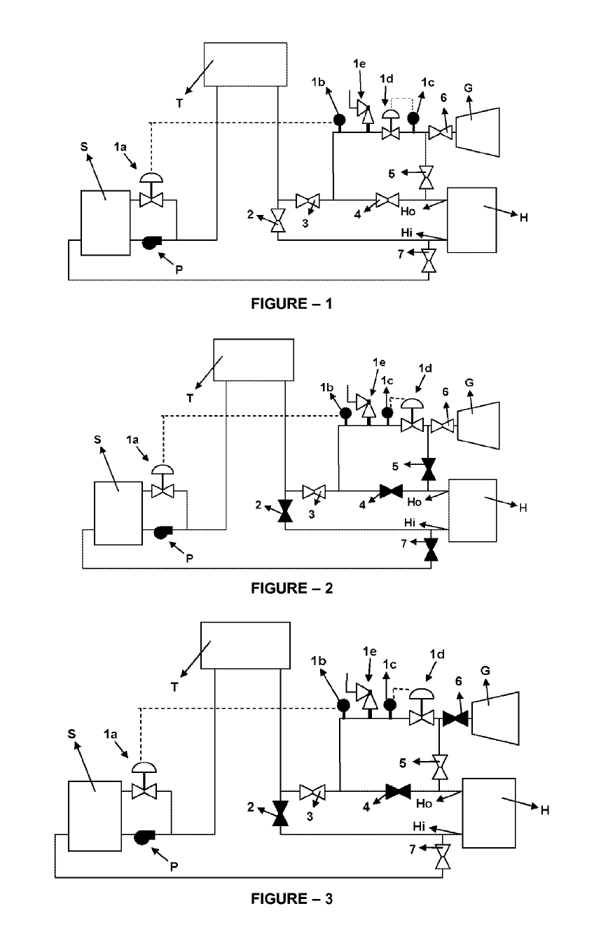

In another embodiment shown in FIG. 3, the case that the steam received from the thermal unit (T) is transferred only to the heat storage unit (H) is exemplified, and thus heat storage in said storage unit (H) is ensured. In said embodiment, the steam received from said thermal unit (T) is taken to the heat storage unit (H) from the outlet (Ho) of the heat storage unit (H) and transfers its energy inside the heat storage unit (H). Then, the fluid in the form of a liquid and/or steam exit from the inlet (Hi) of the heat storage unit (H) and is preferably sent back to the liquid source (S). In this embodiment, the vane (6) ensuring the steam passage to the generator (G) and the vanes (2, 4) ensuring the transfer of the steam received from the thermal unit (T) to the generator (G) by passing from the heat storage unit (H) are in closed position, and only the vanes (3, 5, 7) ensuring the transfer of the steam received from the thermal unit (T) to the heat storage unit (H) are in open position. Accordingly, the steam coming from the thermal unit (T) is taken to the heat storage unit (H), and the steam losing its heat (or the liquid if it losses too much energy) is sent to the liquid source (S) from the inlet (Hi) of the heat storage unit (H). Preferably in this embodiment, the steam received from the thermal unit (T) is not directly sent to the outlet (Ho) of the heat storage unit (H) and is sent to the heat storage unit (H) after it passes from the pressure sensor (1b), temperature sensor (1c) and/or temperature regulator (1d). Therefore, the temperature and/or the pressure of the steam sent to the steam storage unit (H) can be kept under control.

In the embodiment shown in FIG. 4, the operation of the solar energy system developed in the case, that the steam received from the thermal unit (T) is not in the desired temperature, is exemplified. In this embodiment, the vane (2) ensuring the entrance of the steam coming from the thermal unit (T) into the heat storage unit (H) preferably from the inlet (Hi) part of the unit (H) and the vanes (4, 6) ensuring the transfer of the steam to the generator (G) preferably from the outlet (Ho) part of the heat storage unit (H) are in open position; and the vanes (3, 7) ensuring the transfer of the steam coming from said thermal unit (T) directly to the generator (G) or passing only through the heat storage unit (H) are in closed position. Moreover, the vane (5) ensuring the direct connection between the generator (G) and the outlet (Ho) of the heat storage unit (H) is brought to the closed position; thus it is ensured that the steam sent from the heat storage unit (H) to the generator (G) is passed from the pressure sensor (1b), the temperature sensor (1c) and/or the temperature regulator.

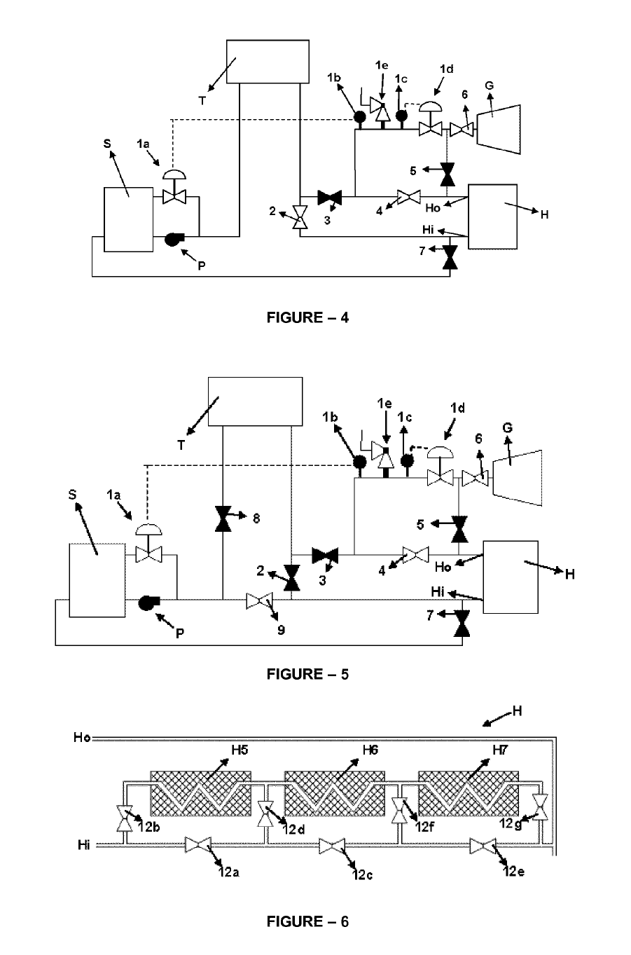

In another alternative embodiment shown in FIG. 5, the solar energy system comprises a vane (8) located at the inlet of the thermal unit (T), and at least one another vane (9) which can ensure connection between the inlet and outlet of said thermal unit (T) and can interrupt this connection. In this embodiment, the vanes (8, 2), which are located at the inlet and outlet of said thermal unit (T), are in closed position and prevent the passage of the liquid coming from the liquid source (S) to the thermal unit (T). Moreover, the vane (9) ensuring connection between the inlet and outlet of said thermal unit (T) is in open position. Therefore, the liquid from the liquid source (S) is taken into the heat storage unit (H) from the inlet (Hi) of said unit (H) and sent to the generator (G) by exiting from the outlet part (Ho) of said unit (H) after heated and evaporated in the heat storage unit (H). Therefore, the liquid coming from the liquid source (S) goes directly to the heat storage unit (H) instead of said thermal unit (T) when the sun rays does not reach to the thermal unit (T) at night as well, and the liquid turns into the steam at desired temperature by being heated via the heat stored therein previously. Then, by transferring the steam at desired temperature to the generator (G), the steam, which is to be necessarily used in the generator (G) even at night when the thermal unit (T) cannot be used, is able to be obtained.

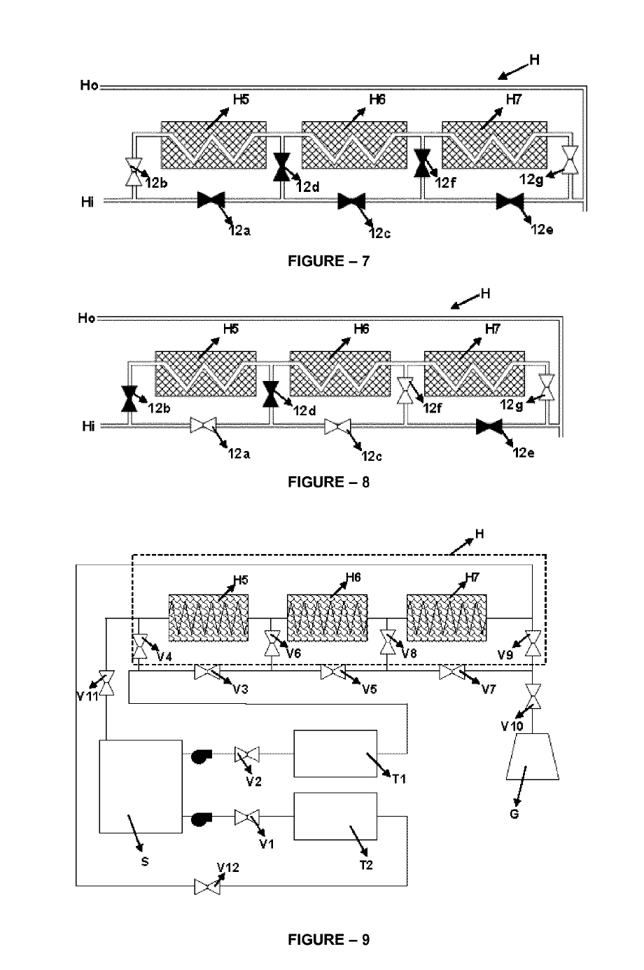

FIGS. 6-8 and FIGS. 9-14 show respectively an exemplary embodiment of a heat storage unit (H) used in the solar energy system and an exemplary solar energy system in which this exemplary embodiment of the heat storage unit (H) is used. The heat storage unit (H), which is in multi-pieced structure in FIGS. 6-8, comprises at least two compartments (H5, H6, H7) which are in structures independent from one another and each one of which has the feature of heat storage and in connection with one another; and a plurality of vanes (12a-12g) which control the liquid and/or steam passage among these compartments (H5, H6, H7). Each one of these compartments (H5, H6, H7) comprises elements such as preferably molten salt, concrete, and/or rock to which hot steam transmits its heat. In this example, when the heat is desired to be stored in the heat storage unit (H), firstly the compartment (third compartment (H7)) in connection with the outlet (Ho) of the heat storage unit (H) is heated; then, all the compartments (respectively the second compartment (H6) and the first compartment (H5)) are respectively heated towards the compartment (H5) in connection with the inlet (Hi). Moreover, while liquid and/or steam is heated via the heat storage unit (H) in the example, the liquid and/or steam to be heated is taken to the heat exchange unit (H) by passing the inlet (Hi) firstly through the compartment (e.g. through the first compartment (H5) as shown in FIG. 7) in connection with the inlet (Hi). Thus, as given above, the operation of the compartments (H5, H6, H7) in temperatures different from each other is ensured; and for example even if the temperature of the first and second compartments (H5, H6) decreases under a predetermined temperature, since the temperature of the third compartment (H7) is still high enough, obtaining the steam in desired temperature is ensured. In this embodiment, preferably, at least three temperature sensors (not shown in figures) which are in connection with vanes (12a-12g) adjusting fluid passage to the compartments (H5, H6, H7) and which are located such that at least one is in a place where the first compartment (H5) ensures fluid passage to the second compartment (H6); at least one in a place where the second compartment (H6) ensures fluid passage to the third compartment (H7); and at least one is in a place where the third compartment (H7) ensures fluid passage to the generator (G) are provided. Therefore, the temperature of the steam which comes from the thermal unit (T) but does not have the temperature necessary for operating the generator (G) for instance, is compared with the temperatures measured by these sensors, and it is ensured that the steam coming from thermal unit (T) is transferred to the compartments (H5, H6, H7) having the temperature equal to the steam or higher than the steam. Thus, the operation efficiency of the solar energy system increases.

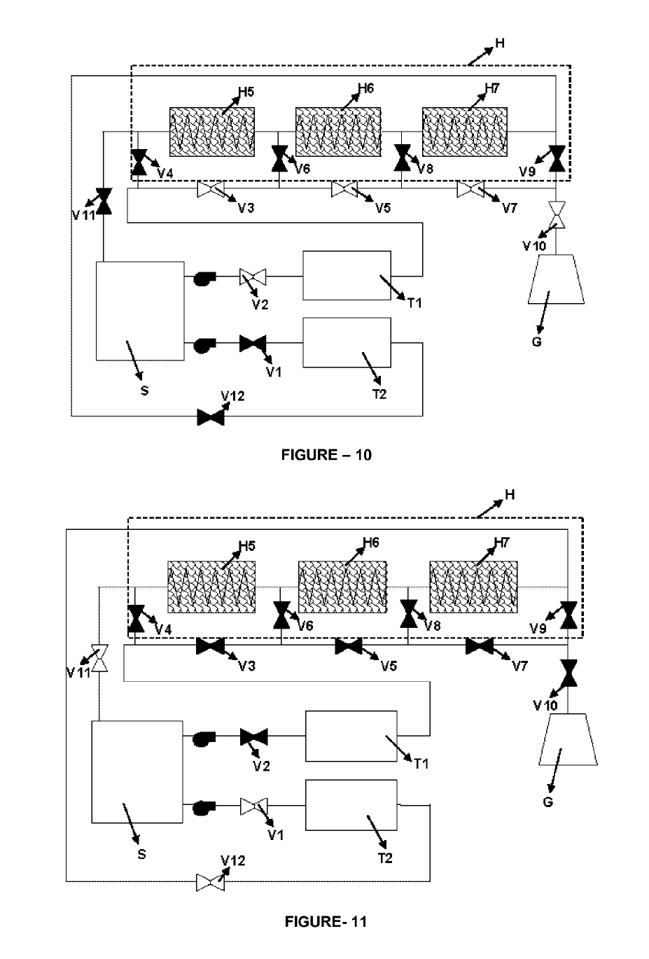

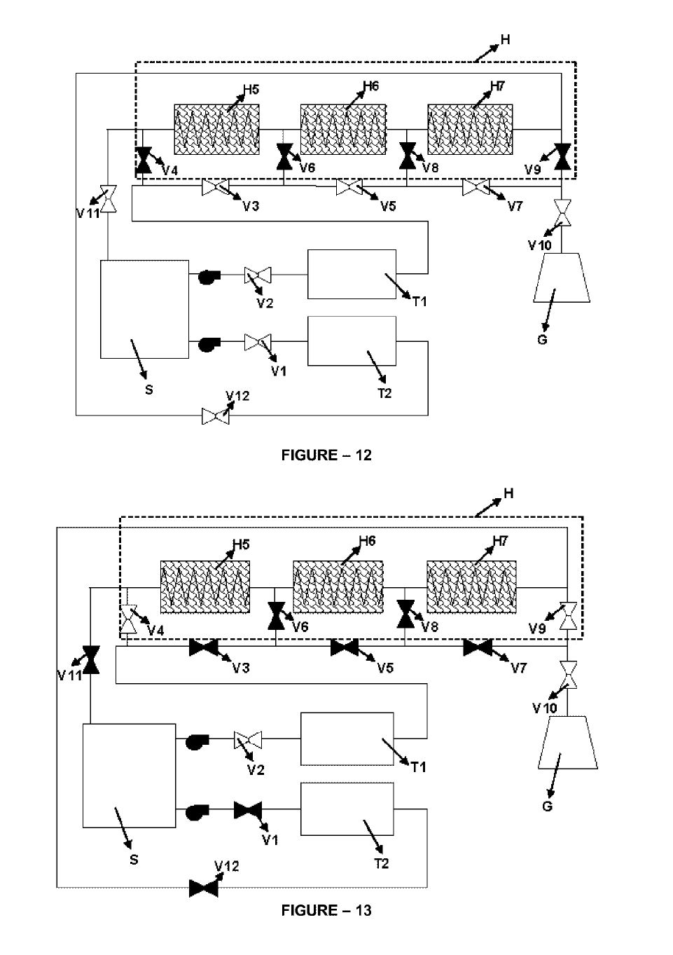

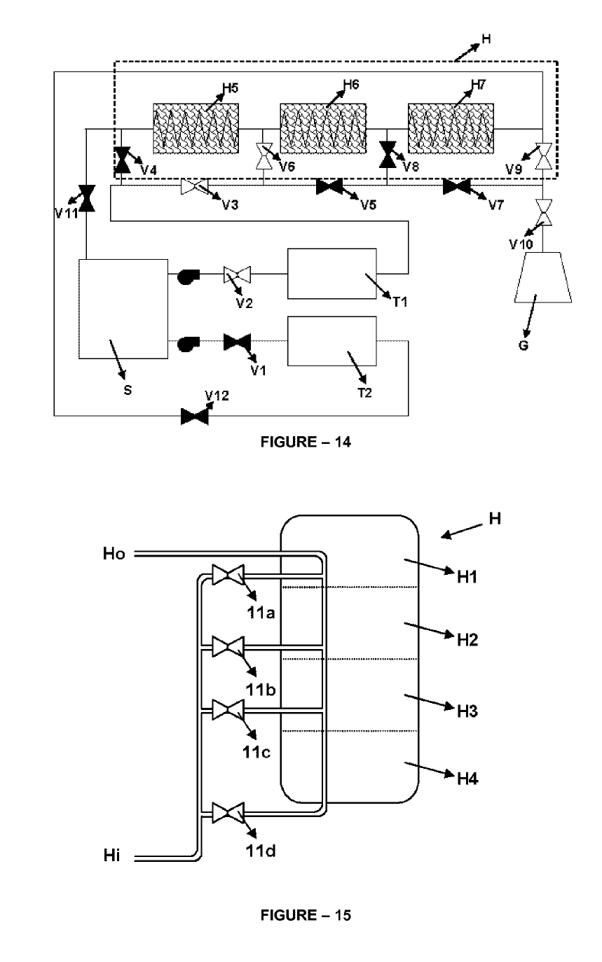

FIGS. 9-14 show exemplary embodiments of a solar energy system which is described above and which comprises the heat storage unit (H) exemplified in FIGS. 6-8. In this embodiment, the solar energy system preferably comprises at least two thermal units (T1, T2) which are able to operate together and one of which is directly in connection with the heat storage unit (H), and the other one of which is directly in connection with the generator (G). In this embodiment, as shown in FIG. 10, the steam obtained from a thermal unit (T1) is able to be sent to the generator (G). Alternatively, as shown in FIG. 11, the steam obtained in the other thermal unit (T2) is able to be used for storing heat in the heat storage unit (H). Therefore, as shown in FIG. 12, while hot steam is sent to the generator (G) by using a thermal unit (T1) the heat is able to be stored in the heat storage unit (H) by using the other thermal unit (T2). Besides, as shown in FIG. 13, in the event that the steam produced in the thermal unit (T1) which is in connection with the generator (G) directly does not have sufficient temperature (e.g. in the event that the sun rays decreases or is prevented for a short period of time), the steam from said thermal unit (T1) is brought to the desired temperature by passing through the heat storage unit (H). Thus, the steam in desired temperature and pressure is able to be sent to the generator (G) at the sunrise/sunset when the effects of the sun rays are reduced or even when the amount of sunlight reaching the thermal unit (T1) is decreased for a short time (e.g. the sunlight gets blocked by a cloud). In this embodiment, since the liquid and/or the steam coming from the thermal unit (T1) which is directly associated with the generator (G) will be directed to the heat storage unit (H) in the event that the liquid and/or the steam does not have the temperature necessary for operating the generator (G), the transfer element (P) ensuring liquid transfer from the liquid source (S) to the thermal unit (T2) which is directly associated with the heat storage unit (H) switches to the off position. Therefore, while the heat storage unit (H) is used for heating, the heat storage process is stopped and an effective operation of the system is ensured. Moreover another embodiment shown in FIG. 14 exemplifies the situation which compares the temperatures of the compartments (H5, H6, H7) provided in the heat storage unit (H) with the temperature of the liquid and/or the steam coming to said unit (H) in the event that the liquid and/or the steam from the thermal unit (T1) directly associated with the generator (G) is transferred to the heat storage unit (H) for heating. In other words, if the temperature of the steam coming from the thermal unit (T1) associated with the generator (G) is higher than the temperature of the first compartment (H5) but lower than the temperature of the second and third compartments (H6, H7), the vane (V4) controlling the passage from the thermal unit to the first compartment (H5) switches to the off position. The vane (V3) of the vanes (V3, V5, V7) ensuring direct connection between the thermal unit (T1) and the generator (G) close to the first compartment (H5) is brought open position and the others remain in closed position. In addition, the vane (V6) controlling the passage from the thermal unit (T1) to the second compartment (H6) is also brought to open position, and therefore the passage of the steam coming from the thermal unit (T1) to the second compartment (H6) without going to the first compartment (H5) is ensured and the heating of the steam to the desired temperature is ensured. Then, the steam reached to the desired steam is transferred to the generator (G) and thus, the system is operated effectively.

Another exemplary embodiment of the heat storage unit (H) and an exemplary solar energy system in which this exemplary heat storage unit (H) is used are respectively shown in FIGS. 15-17 and FIGS. 18-23. The heat storage unit (H) in multi-pieced structure (H), whose exemplary views are shown in FIGS. 15-17 comprises at least two parts (H1-H4) which are preferably insulated from each other in this embodiment and at least one vane (11a-11d) for each part (H1-H4) ensuring the liquid and/or steam entrance to the each part (H1-H4) from the inlet (Hi) of the heat storage unit (H) separately. In each part (H1-H4), at least one tray (not shown in figures) filled with liquid therein is provided, and the structure (e.g. pipe) ensuring the connection between the inlet (Hi) and outlet (Ho) of the heat storage unit (H) is passed through these parts (H1-H4). Moreover, the connection of these vanes (11a-11d) is ensured with the connection structure separately. As given in the aforementioned embodiments, while the heat is stored in the heat storage unit (H), hot steam is received from the outlet (Ho) of the heat storage unit (H). Thus, firstly the part (first part (H1)) of the heat storage unit (H) which is close to the outlet (Ho), which is preferably in connection with the outlet (Ho) and which is provided preferably at the upper part of the heat storage unit (H); then the other parts (H2-H4) are heated. During the heat storage, hot steam reached to the first part (H1) from the outlet (Ho) of the heat storage unit (H) heats and evaporates the liquid in the tray provided therein; therefore the heat storage of the absorption elements (e.g. rock pieces) provided in the first part (H1) is ensured both thanks to hot steam coming from the thermal unit (T, T1, T2) and to the evaporation of the liquid in the tray provided in this part (H1). The steam received from the outlet (Ho) of the heat storage unit (H) gives some of its heat to the first part (H1) firstly, then gives remaining heat amount to the other parts (H2-H4) respectively and exits from the inlet (Hi) by passing from the vane (11d) close to the inlet (Hi). Since the temperature of the steam decreases while passing each part (H1-H4), the part (the first part (H1)) close to the outlet (Ho) has the highest temperature while the part (the fourth part (H4)) close to the inlet (Hi) has the lowest temperature. However, after the first part (H1) reaches to the heat saturation, the heat transfer does not occur between the steam received from the outlet (Ho) and the first part (H1), thus the steam transfers the energy it carries to the other parts (H2, H3, H4). Accordingly, equalization of the temperatures of all parts (H1-H4) thanks to the heat saturation of the second part (H2), the third part (H3), and the fourth part (H4) is ensured.

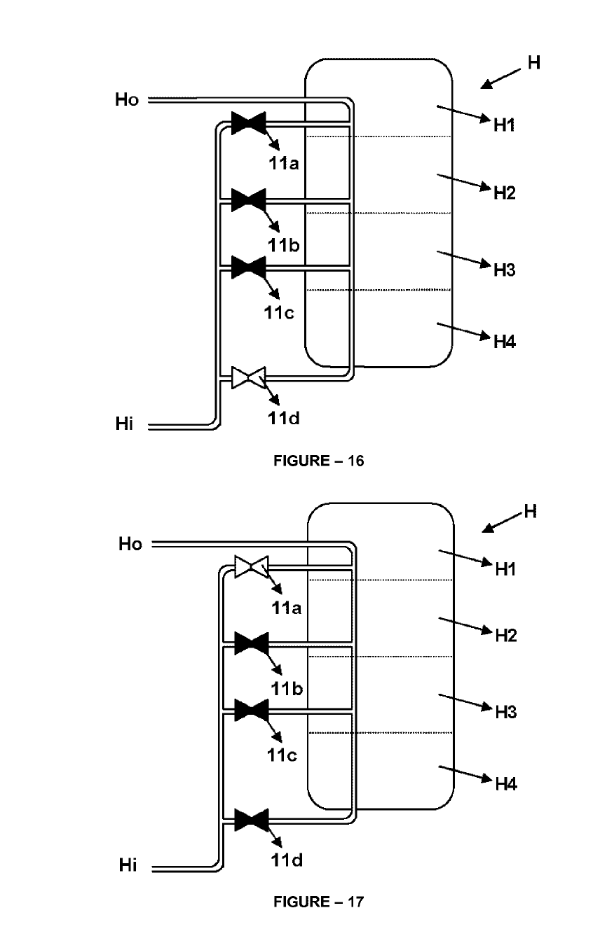

In the embodiment of heating the liquid and/or steam coming from the liquid source (S) or thermal unit (T) by using the heat storage unit (H), the steam and/or the liquid received from the inlet (Hi) of the heat storage unit (H) is firstly taken from the vane (11d) to which the part (e.g. the fourth part (H4) as shown in FIG. 16) preferably provided in the lower side of the heat storage unit (H) and closest to the inlet (Hi) is connected. While the liquid and/or the steam advance from the inlet (Hi) to the outlet (Ho), it passes through the parts (respectively H1-H4) of the heat storage unit (H) and is heated via the heat stored therein. Therefore, the steam in desired temperature is received from the outlet (Ho). In this embodiment, at least one temperature sensor (not shown in figures) is provided preferably in each one of the parts (H1-H4), and the sensor in each part (H1-H4) is associated with the vane (11a-11d) adjusting the liquid and/or the steam passage to the related part (H1-H4). The temperature of the liquid and/or the steam to be heated is compared with the temperature of each part (H1-H4) in the heat storage unit (H) (the comparison is respectively made beginning preferably from the part provided in the lower side of the heat storage unit (H)); and if the temperature of a part (H1-H4) is lower than the liquid and/or the steam coming to the heat storage unit, the vane (11a-11d) controlling the liquid and/or steam passage to that part (H1-H4) is brought to the closed position and prevents the liquid and/or steam taking to the part (H1-H4). In other words, if for example the temperature of the fourth part (H4) is lower than the temperature of the liquid and/or steam to be heated in the heat storage unit (H), the vane (11d) adjusting the liquid and/or steam passage to said part (H4) is brought to the closed position; and thus the liquid and/or steam passage to the fourth part (H4) is prevented. In this case, the temperature of the liquid and/or the steam is compared with the temperature of the third part (H3); and if the temperature of the part (H3) is equal to or higher than the temperature of the liquid and/or steam, the vane (11c) adjusting the liquid and/or steam passage to the part (H3) is brought to the open position, and the liquid and/or steam is ensured to be heated by coming said part (H3). Therefore, by preventing energy loss of the liquid and/or steam taken to the heat storage unit (H) in the low temperature parts (H1-H4), the efficiency of the solar energy system is increased. Moreover, total pressure of the system is not increased thanks to not giving the steam externally into the heat storage unit (H).

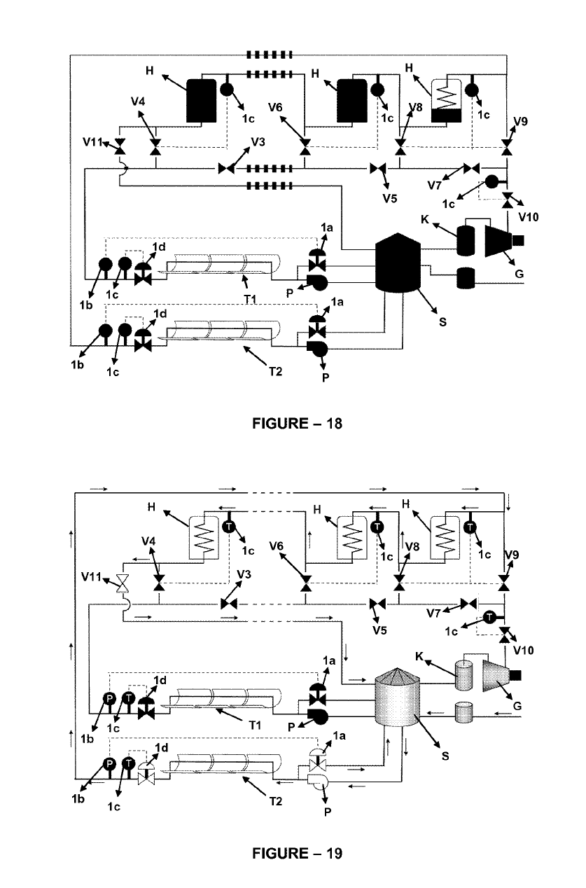

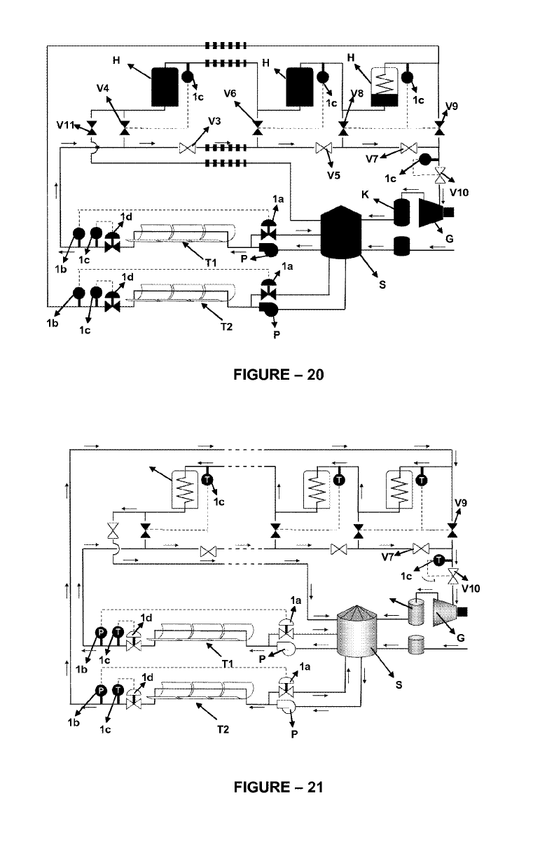

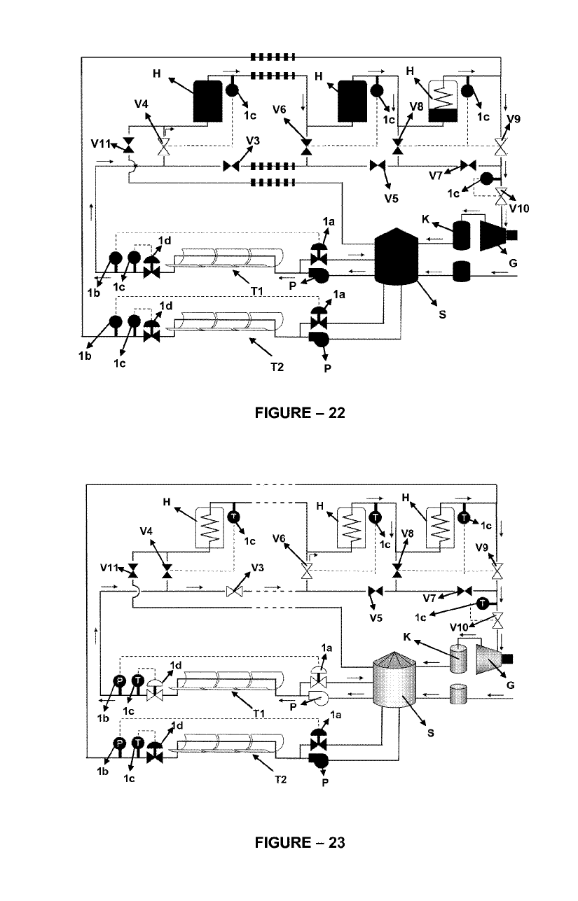

The FIGS. 18-23 shows exemplary embodiments of a solar energy system comprising the heat storage unit (H) which is described above and exemplified in FIGS. 15-17. In this embodiment, the solar energy system preferably comprises more than one heat storage units (H) and at least two thermal units (T1, T2) which are able to operate together, one of which is associated with the heat storage unit (H) while the other one is associated directly with the generator (G). In this embodiment, the steam obtained in a thermal unit (T1) as shown in FIG. 20 is able to be sent to the generator (G) directly. Alternatively, the steam obtained in another thermal unit (T2) as shown in FIG. 19 is able to be used in the heat storage unit (H) for storing heat. Therefore, as shown in FIG. 21, while hot steam is sent to the generator (G) by using a thermal unit (T1) heat is able to be stored in the heat storage unit (H) by using the other thermal unit (T2). In this embodiment, as in the other embodiments, at least one pressure sensor (1b) and one temperature sensor (1c) measuring pressure and temperature of the steam coming from the thermal units (T1, T2) are provided. Furthermore, at least one temperature regulator (1d) located between the temperature sensor (1c) and the thermal unit (T1, T2) and connected to the temperature sensor (1c) is provided; and at least one pressure regulator (1a) located between the liquid source (S) and the thermal units (T1, T2) and connected to the pressure sensor (1b) is provided. In said embodiment, thanks to using a plurality of heat storage unit (H) which are insulated from one another but in connection with one another, it is ensured that the steam transferred to the generator is always at desired temperature and quality.

In another preferred embodiment shown in the figures, the solar energy system comprises at least one temperature sensor (1c) in a place where hot steam comes in the generator (G) and at least one another temperature regulator (1d) which is in connection with the temperature sensor (1c) and adjusts the temperature of the steam entering into the generator (G) according to the information received from the sensor (1c). Therefore, an effective solar energy system is developed by increasing the control points located in the system.

In another alternative embodiment, the solar energy system also comprises at least one pressure relief valve (1e) located in the generator (G) inlet; and thus increases security of the system.

Also in another exemplary embodiment, the solar energy system of the invention comprises at least one condenser (K) ensuring that the waste steam from the generator (G) is condensed and returns to the liquid source (S). Thus, by ensuring the usage of the waste steam from the generator (G), an efficient solar energy system is able to be obtained.

In the solar energy system, it is ensured that the steam in desired temperature and pressure is sent to the generator (G) in every moment of a day (day/night, when the amount of the received sunlight changes). Thus, by using solar energy, a different energy (e.g. electric energy or mechanical energy) is able to be produced in any moment of a day. Moreover, since only one fluid (liquid or steam form of the liquid received from the liquid source) is used when the solar energy is received, stored and converted into another energy, in other words since heat exchange is not made between different fluids, energy losses to be occurred during heat exchange are prevented; and efficient operation of the solar energy system is ensured.

I claim:

1. A solar energy system comprising:
a liquid source;
a thermal unit in which liquid taken from the liquid source is evaporated by heating via solar energy;
a transfer element configured to transfer the liquid from the liquid source;
a heat storage unit comprising a plurality of compartments, wherein the heat storage unit is configured to transfer steam from the thermal unit and is configured to store heat by absorption of heat of the steam, and wherein the heat storage unit is configured to evaporate the liquid passed through the heat storage unit, the liquid evaporated using the heat stored in the heat storage unit;
a generator configured to produce a motional energy via steam energy when the steam produced in the thermal unit or in the heat storage unit is transferred therethrough; and
a plurality of vanes which control transfer of the steam originated from the thermal unit selectively to the heat storage unit or to the generator.

2. A system according to claim 1, wherein said heat storage unit comprises an inlet and an outlet.

3. A system according to claim 1, wherein said generator is in a structure configured to convert the motional energy into an electrical energy.

4. A system according to claim 1, wherein said thermal unit comprises an inlet in which the liquid coming from the liquid source is taken and an outlet from which the liquid heated therein exits.

5. A system according to claim 1, wherein said thermal unit is in a parabolic solar trough.

6. A system according to claim 4, further comprising a pressure sensor located proximate the outlet of the thermal unit which measures the pressure of the steam passing through the outlet of the thermal unit; and a pressure regulator located proximate an outlet of the liquid source, which is in connection with said pressure sensor, and configured to ensure that the steam pressure measured by the pressure sensor reaches a desired level by return of an amount of liquid received from the liquid source back to the liquid source according to pressure information received from the pressure sensor.

7. A system according to claim 4, further comprising a temperature sensor located proximate the outlet of said thermal unit which measures the temperature of the steam passing through the outlet of said thermal unit; and a temperature regulator which is placed between the temperature sensor and the thermal unit, which is connected with the temperature sensor, and which is configured to regulate the temperature by adjustment of the flow rate of liquid or steam received from the thermal unit depending on the temperature value measured by the temperature sensor.

8. A system according to claim 4, further comprising a vane located proximate the outlet of the thermal unit and at least one other vane configured to ensure connection and disconnection between the inlet and outlet of the thermal unit.

9. A system according to claim 1, wherein said heat storage unit comprises at least two compartments and at least one vane for each compartment configured to ensure that liquid or steam from the inlet of the heat storage unit is selectively transferred through each compartment separately.

10. A system according to claim 9, wherein said compartments are heat insulated.

11. A system according to claim 9, further comprising at least two thermal units configured to operate together, wherein at least one of the at least two thermal units is configured to direct steam to the heat storage unit and at least another of the at least two thermal units is configured to direct steam to the generator.

12. A system according to claim 9, further comprising a tray positioned in each of the at least two compartments, wherein the tray is filled with liquid.

13. A system according to claim 9, further comprising a plurality of temperature sensors which are in connection with vanes configured to selectively transfer the liquid or steam through each compartment, wherein at least one of the plurality of temperature sensors is positioned in each compartment.

14. A system according to claim 2, wherein said heat storage unit comprises at least two compartments and at least one vane for each compartment configured to ensure that liquid or steam from the inlet of the heat storage unit is selectively transferred through each compartment separately.

15. A system according to claim 1, wherein the heat storage unit comprises at least two elements which are independent from one another and each of which are configured to store heat, and wherein a plurality of vanes are configured selectively transfer the liquid or steam through one or each of the least two elements.

16. A system according to claim 15, further comprising at least two thermal units configured to operate together, wherein at least one of the at least two thermal units is configured to direct steam to the heat storage unit and at least another of the at least two thermal units is configured to direct steam to the generator.

17. A system according to claim 2, wherein the heat storage unit comprises at least two elements which are independent from one another and each of which are configured to store heat, and wherein a plurality of vanes are configured selectively transfer the liquid or steam through one or each of the least two elements.

18. A system according to claim 1, further comprising a temperature sensor positioned proximate a steam inlet of the generator and a temperature regulator connected with the temperature sensor, configured to adjust the temperature of the steam entering the generator in accordance with information received from the temperature sensor.

19. A system according to claim 1, further comprising a pressure relief valve located proximate an inlet of the generator.

20. A system according to claim 1, further comprising a condenser configured to condense waste steam from the generator and return the condensed waste steam to the liquid source.
